(19) United States
(12) Patent Application Publication
(10) Pub. No.: US 2018/0312185 A1
(43) Pub. Date: Nov. 1, 2018

(54) CART FOR A REEL

(71) Applicant: General Cable Technologies Corporation, Highland Heights, KY (US)

(72) Inventors: Jared D. Weitzel, Cincinnati, OH (US); Cody R. Davis, Maineville, OH (US)

(21) Appl. No.: 15/965,282

(22) Filed: Apr. 27, 2018

Related U.S. Application Data
(60) Provisional application No. 62/490,905, filed on Apr. 27, 2017.

(51) Int. Cl. B62B 3/10

(52) U.S. Cl. CPC B62B 3/104; B62B 2301/04; B62B 2202/025

(57) ABSTRACT

A wheeled cart includes first and second support arms, a cross member, a first roller, a second roller, and a plurality of wheels. Each of the first and second support arms includes a distal end, a proximal end, and a central portion extending between the distal and proximal ends. The cross member is coupled to each of the first support arm and the second support arm such that the cross member extends laterally between the first support arm and the second support arm. The first and second rollers are rotatably coupled to the central portion of the first and second support arms, respectively. Each wheel of the plurality of wheels is rotatably coupled with one of the distal end of the first support arm, the distal end of the second support arm, the proximal end of the first support arm, and the proximal end of the second support arm.

### REFERENCE TO RELATED APPLICATION

This application claims priority of U.S. provisional patent application Ser. No. 62/490,905, entitled CART FOR SPOOL, filed Apr. 27, 2017, and hereby incorporates this provisional patent application by reference herein in its entirety.

### TECHNICAL FIELD

The apparatus and methods described below generally relate to a wheeled cart for transportation of a reel of material, such as a cable reel. The wheeled cart can include a pair of rollers that facilitate dispensation of spooled material from the reel while being supported by the wheeled cart.

### BACKGROUND

A reel can include a drum that is configured to accommodate a variety of different products such as cable, wire, hose, tubing, textile, or carpeting, that can be spooled onto the drum and dispensed therefrom by rotating the reel. Dispensing the product from the reel with the drum resting on the ground can be cumbersome and time consuming. Various types of conventional supports are provided that support the reel while allowing for rotation of the reel to permit easy dispensation of the product from the reel. One example of such a conventional support includes a pair of stands that are positioned alongside the outer flanges of the reel and support a rod that is provided through a center of the reel. The stands hold the reel off of the ground to allow for rotation of the reel about the rod. Another example of a conventional support is a stationary reel payoff that includes a plurality of elevated wheels that support the reel. When the reel is rolled onto the stationary reel payoff and onto the wheels, the wheels can allow the reel to rotate to facilitate dispensation of product therefrom. Two examples of stationary reel payoffs are illustrated in Exhibit A. Such conventional reel/drum supports do not facilitate effective transportation of the reel while installed on the support.

### SUMMARY

In accordance with one embodiment, a wheeled cart for a reel is provided. The wheeled cart includes a first support arm, a second support arm, a cross member, a first roller, a second roller, a locking assembly, and a plurality of wheels. The first support arm includes a distal end, a proximal end, and a central portion extending between the distal end and the proximal end. The second support includes a distal end, a proximal end, and a central portion extending between the distal end and the proximal end. The cross member is coupled to each of the first support arm and the second support arm such that the cross member extends laterally between the first support arm and the second support arm. The first roller is rotatably coupled to the central portion of the first support arm. The second roller is rotatably coupled to the central portion of the second support arm. The locking assembly is associated with the first roller and is configured to facilitate selective locking of the first roller. Each wheel of the plurality of wheels is rotatably coupled with one of the distal end of the first support arm, the distal end of the second support arm, the proximal end of the first support arm, and the proximal end of the second support arm.

In accordance with another embodiment, a wheeled cart for a reel is provided. The wheeled cart includes a first support arm, a second support arm, a cross member, a first roller, a second roller, a plurality of wheels, and a brake assembly. The first support arm includes a distal end, a proximal end, and a central portion extending between the distal end and the proximal end. The second support includes a distal end, a proximal end, and a central portion extending between the distal end and the proximal end. The cross member is coupled to each of the first support arm and the second support arm such that the cross member extends laterally between the first support arm and the second support arm. The first roller is rotatably coupled to the central portion of the first support arm. The second roller is rotatably coupled to the central portion of the second support arm. Each wheel of the plurality of wheels is rotatably coupled with one of the distal end of the first support arm, the distal end of the second support arm, the proximal end of the first support arm, and the proximal end of the second support arm. The brake assembly is configured to prevent rolling of the wheeled cart on the plurality of wheels.

In accordance with yet another embodiment, a wheeled cart for a reel is provided. The wheeled cart includes a first support arm, a second support arm, a cross member, a first roller, a second roller, a locking assembly, a plurality of wheels, and a brake assembly. The first support arm includes a distal end, a proximal end, and a central portion extending between the distal end and the proximal end. The second support includes a distal end, a proximal end, and a central portion extending between the distal end and the proximal end. The cross member is coupled to each of the first support arm and the second support arm such that the cross member extends laterally between the first support arm and the second support arm. The first roller is rotatably coupled to the central portion of the first support arm. The second roller is rotatably coupled to the central portion of the second support arm. The locking assembly is associated with the first roller and is configured to facilitate selective locking of the first roller. Each wheel of the plurality of wheels is rotatably coupled with one of the distal end of the first support arm, the distal end of the second support arm, the proximal end of the first support arm, and the proximal end of the second support arm. The brake assembly is configured to prevent rolling of the wheeled cart on the plurality of wheels.

### BRIEF DESCRIPTION OF THE DRAWINGS

Various embodiments will become better understood with regard to the following description, appended claims and accompanying drawings wherein:

FIG. 1 is a front isometric view depicting a wheeled cart for a reel, in accordance with one embodiment;

FIG. 2 is a rear isometric view depicting the wheeled cart of FIG. 1;

FIG. 3 is a cross sectional view taken along the line 3-3 in FIG. 1;

FIG. 4 is an enlarged side view of the wheeled cart of FIG. 1 with a locking pin of a locking assembly shown in a locked position;

FIG. 5 is an enlarged side view of the wheeled cart of FIG. 4 but with the locking pin shown in an unlocked position;

FIG. 6 is a front isometric view depicting a wheeled cart for a reel, in accordance with another embodiment;

FIG. 7 is a rear isometric view depicting the wheeled cart of FIG. 6; and

FIG. 8 is an enlarged view of a foot assembly of a wheeled cart, in accordance with yet another embodiment.

### DETAILED DESCRIPTION

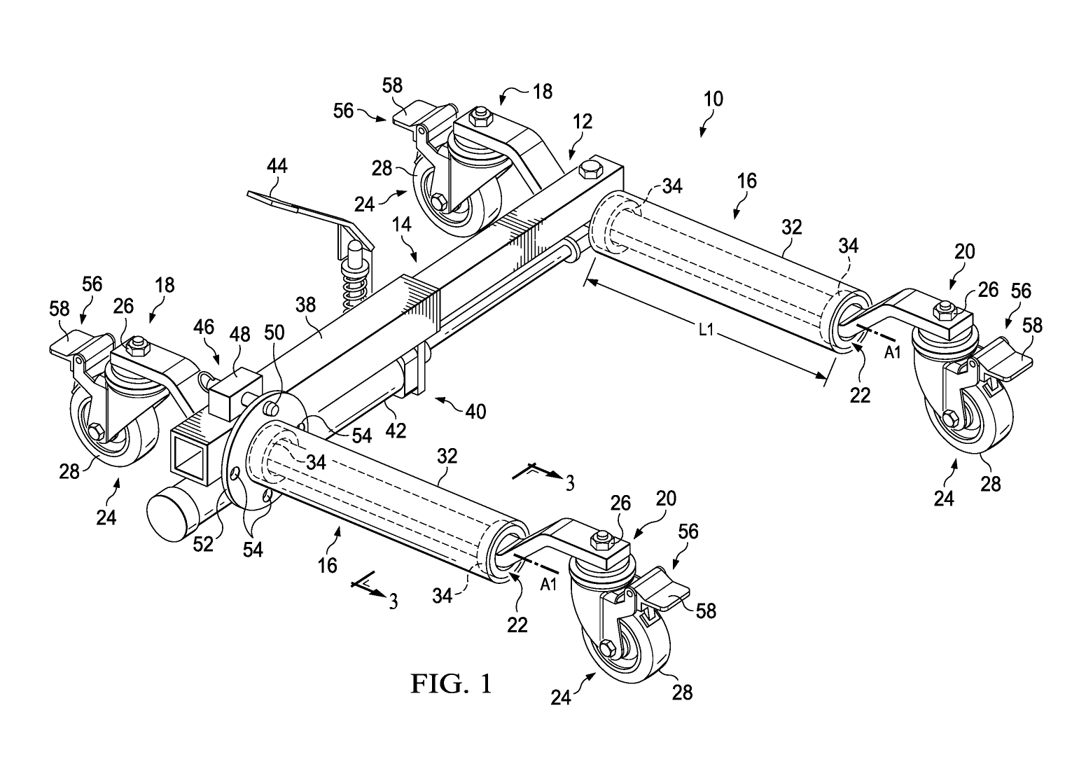

Embodiments are hereinafter described in detail in connection with the views and examples of FIGS. 1-8, wherein like numbers indicate the same or corresponding elements throughout the views. A wheeled cart 10, in accordance with one embodiment, is generally depicted in FIG. 1 and can include a frame 12 having a cross member 14 and a pair of support arms 16 coupled with the cross member 14. The cross member 14 and support arms 16 can be formed of a metal or metal alloy, such as steel or aluminum, or any of a variety of suitable alternative materials such as, for example, fiberglass, carbon fiber or other composite. The cross member 14 and the pair of support arms 16 can be coupled together through welding, with bolts (not shown), or any of a variety of other suitable attachment arrangements.

Each support arm 16 can include a distal end 18, a proximal end 20, and a central portion 22 that extends between the distal end 18 and the proximal end 20. The cross member 14 can extend laterally between the support arms 16 and can be coupled with the central portions 22 at a location that is more proximate the proximal ends 20 of the support arms 16, such that the distal ends 18 are spaced further from the cross member 14 than the proximal ends 20. The frame 12 can be devoid of a cross member (e.g., 14) at the distal ends 18 such that the frame 12 is substantially C-shaped.

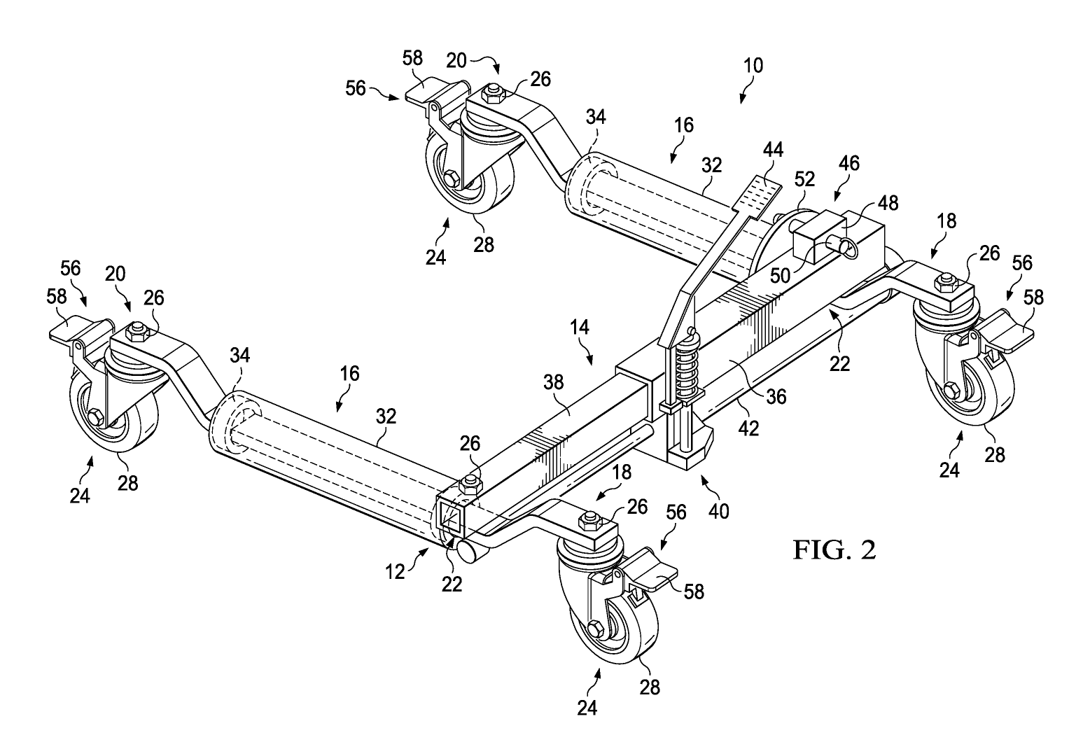

A plurality of wheel assemblies 24 can be coupled to the proximal ends 20 and the distal ends 18 with nuts 26, as illustrated in FIGS. 1 and 2, or can alternatively be coupled through welding, or any of a variety of other suitable coupling arrangements. Each of the wheel assemblies 24 can include a wheel 28 that facilitates rolling of the wheeled cart 10 along a ground surface. In one embodiment, as illustrated in FIGS. 1 and 2, each of the wheel assemblies 24 can comprise casters such that the wheels 28 are configured to swivel with respect to the frame 12 which can allow for ease of rolling and positioning of the wheeled cart 10 with respect to the ground surface in different directions.

The wheeled cart 10 can comprise a pair of rollers 32 which are each rotatably coupled with respective ones of the central portions 22 of the support arms 16. The rollers 32 are each rotatable with respect to one of the central portions 22 about respective rotational axes A1 (FIG. 1) that are defined by each of the central portions 22. As will be described in further detail below, when a reel is loaded onto the wheeled cart 10 and is placed on the rollers 32, the rollers 32 can rotate with respect to the support arms 16 to allow for rotation of the reel to facilitate dispensation of product therefrom.

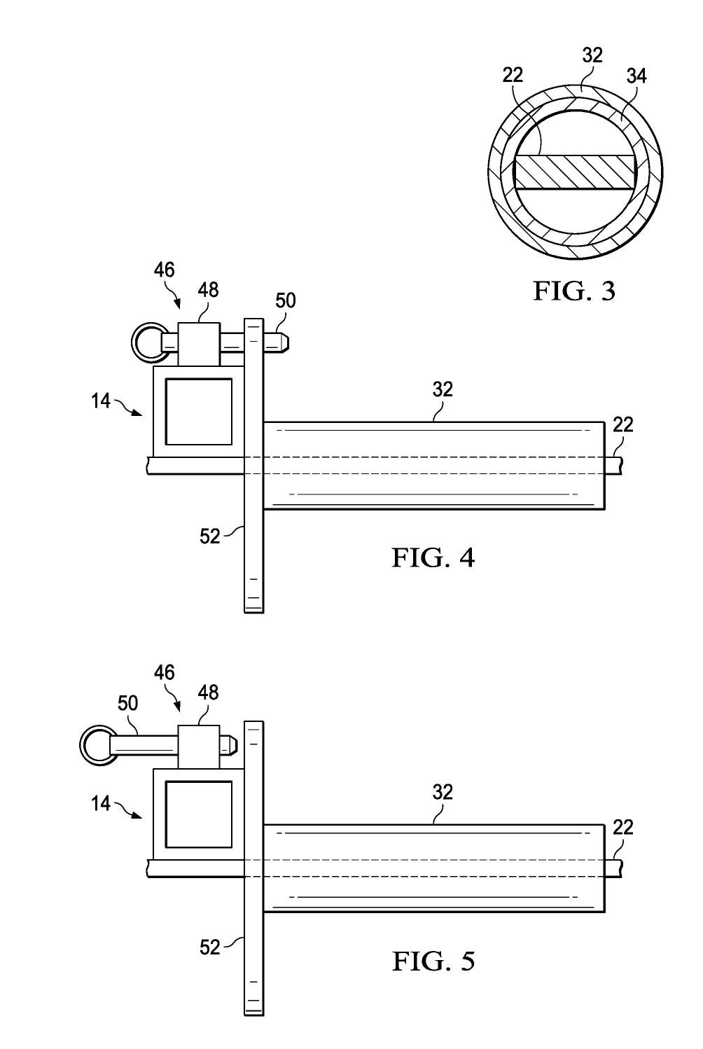

As illustrated in FIG. 1, each of the rollers 32 can be journalled with respect to opposing ones of the support arms 16 by a pair of bearings 34 that are disposed at opposite ends of each roller 32 (e.g., adjacent to the distal ends 18 and the proximal ends 20). Referring now to FIG. 3, one of the bearings 34 is shown to be interposed between the central portion 22 of the support arm 16 and the roller 32. The bearing 34 can be a ball bearing, a sleeve bearing, or any of a variety of bearing arrangements that rotatably supports the roller 32 with respect to the support arm 16. The bearing 34 is shown to be located at the distal end 18 of one of the rollers 32, but can be understood to be representative of the other bearings 34 shown in FIG. 2. Each of the bearings 34 can be strong enough to withstand the weight of a reel provided on the rollers 32. It is to be appreciated, that any quantity of bearings can be provided to journal the rollers 32 with respect to the support arms 16. It is also to be appreciated that the rollers 32 can be rotatably coupled with the central portions 22 with any of a variety of suitable alternative mechanical arrangements that facilitate complete radial spacing (i.e., the roller 32 does not directly contact the central portion 22) of each roller 32 from the associated central portion 22 and enables rotation of the roller 32 with respect to the central portion 22.

Each roller 32 can be substantially cylindrically shaped and can be long enough to substantially entirely (e.g., substantially entirely or entirely) surround the central portion 22. The central portions 22 and the rollers 32 can be sized to correspond to any of a variety of different reel sizes. For example, the central portions 22 and the rollers 32 can have a length L1 that can correspond to the maximum reel traverse or individual reel flange width supported by the cart. In one embodiment, the length L1 can be about 18 inches such that the wheeled cart 10 accommodates a maximum traverse width of about 18 inches. In another embodiment, the length L1 can be about 36 inches such that the wheeled cart 10 can accommodate an industrial sized reel. In another embodiment, the length L1 can be about 6 inches such that the wheeled cart 10 can accommodate one drum flange. In such an embodiment, two individual wheeled carts (e.g., 10) can be provided to support respective ones of the drum flanges.

Each of the central portions 22 of the support arms 16 can be vertically offset from the proximal end 20 and the distal end 18 such that the support arms 16 are substantially U-shaped. The rotational axes A1 can therefore be disposed beneath the proximal and distal ends 18, 20 and located proximate to the rotational axes of the wheels 28 (not shown) which can enhance the center of gravity of a supported reel.

The cross member 14 can be a telescoping member that is configured to change its length to adjust the relative distance between the support arms 16 in order to accommodate for different size reels. In one embodiment, as shown in FIGS. 1 and 2, the cross member 14 can include an outer member 36 and an inner member 38 that is slidable with respect to the outer member 36 between a retracted position (shown) and an extended position (not shown) which can adjust the relative distance between the support arms 16.

In one embodiment, as illustrated in FIGS. 1 and 2, the wheeled cart 10 can include an extension assembly 40 associated with the cross member 14 and configured to selectively change the length of cross member 14. The extension assembly 40 can include a piston 42 that is operatively coupled with each of the outer member 36 and the inner member 38. A pedal 44 can be operatively coupled with the piston 42 such that depression of the pedal 44 (e.g., with a user's foot) can facilitate sliding of the inner member 38 between the retracted position and the extended position. As such, the pedal 44 can be actuated to select the distance between the rollers 32.

Referring now to FIGS. 1, 2, 4, and 5, the wheeled cart 10 can include a locking assembly 46 that is associated with one of the rollers 32 and is configured to facilitate selective locking of the roller 32 to prevent rotation thereof. The locking assembly 46 can comprise a housing 48 that is coupled with the cross member 14 and a pin 50 that is slidably coupled with the housing 48. As illustrated in FIGS. 1 and 2, the roller 32 that is associated with the locking assembly 46 can comprise an annular flange 52 that defines a plurality of apertures 54. As illustrated in FIGS. 4 and 5, the pin 50 can be slidable with respect to the housing 48 between a locked position (FIG. 4) and an unlocked position (FIG. 5). When the pin 50 is in the locked position, the pin 50 can be inserted into one of the apertures 54 of the annular flange 52 to lock the roller 32 and thus prevent it from rotating. When the pin 50 is in the unlocked position, the pin 50 can be spaced from the annular flange 52 to facilitate unlocking of the roller 32 to allow it to rotate.

When a reel is loaded on the wheeled cart 10, the pin 50 can be slid between the locked position and the unlocked position to selectively prevent the reel from rotating. For example, when the reel is being moved with the wheeled cart 10, the pin 50 can be slid into the locked position to prevent the reel from inadvertently rotating. Once the reel is moved to its destination, the pin 50 can be slid into the unlocked position to allow the reel to be rotated to facilitate dispensation of product therefrom.

Referring again to FIGS. 1 and 2, in one embodiment, the wheeled cart 10 can include a brake assembly 56 that is configured to prevent rolling of the wheeled cart 10 on the wheels 28. The brake assembly 56 can include locking pedals 58 that are associated with each of the wheels 28. Each of the locking pedals 58 can be selectively depressed (e.g., with user's foot) into frictional engagement with the wheels 28 which can prevent rotation of the wheels 28 to thus prevent rolling of the wheeled cart 10.

It is to be appreciated that a reel (not shown) can be loaded onto the wheeled cart 10 to facilitate transportation of the reel and dispensation of product therefrom. For example, when a reel (not shown) is sitting on the ground, the wheeled cart 10 can be moved adjacent to the reel and locked in place with the locking pedals 58. The distance between the rollers 32 can then be adjusted (e.g., with the pedal 44) to accommodate the size of the reel. Once the rollers 32 are spaced apart appropriately relative to the size of the reel (not shown), the pin 50 can be slid into the extended position to lock one of the rollers 32 in place. The reel (not shown) can then be loaded onto the support arms 16 such that the drum of the reel contacts both rollers 32 (e.g., such that a rotational axis of the reel is parallel with the rotational axes A1). In one embodiment, the reel (not shown) can be rolled over the locked roller 32 and onto the wheeled cart 10 such that the reel is disposed between both rollers 32. In another embodiment, the reel can be lifted and placed between the rollers 32 (e.g., by a forklift). In another embodiment, when the reel is resting on the ground surface, the arm members 16 can be spaced far enough apart to allow the wheeled cart 10 to be positioned beneath the reel. The roller arms 32 can then be brought closer together by indexing the cross member 14 such that the reel is lifted off the ground. Once the reel is in place on the wheeled cart 10, the wheeled cart 10 can then be unlocked by lifting the locking pedals 58 away from the wheels 28 and the reel can be moved with the wheeled cart 10 to a desired location. Once the reel has reached its desired location, the locking pedals 58 can be depressed to prevent the wheeled cart 10 from rolling. The pin 50 can then be slid into the retracted position to unlock the roller 32 such that the product can be selectively dispensed from the reel. As the product is being withdrawn, the reel can ride on the rollers 32 thereby allowing easy dispensation of the product from the reel. Once the dispensation of the product is complete, the product can be cut from the reel, the pin 50 can be moved to the extended position, the locking pedals 58 can be released and the wheeled cart 10 can be rolled to a different location (e.g., for storage or for another project).

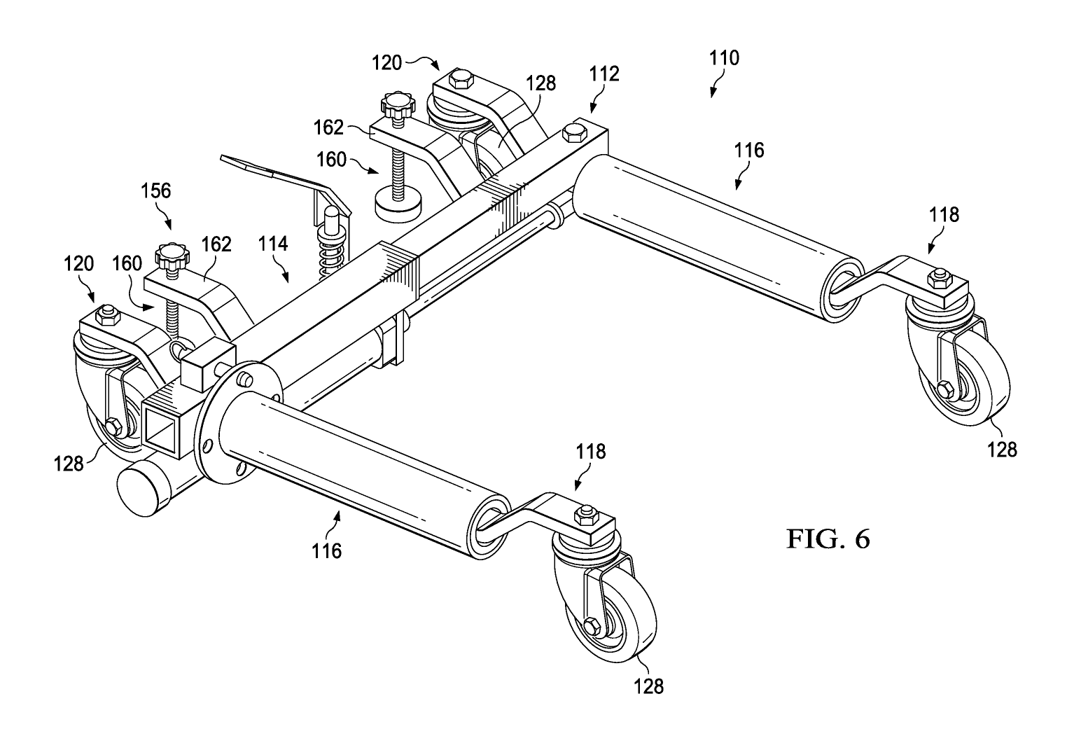

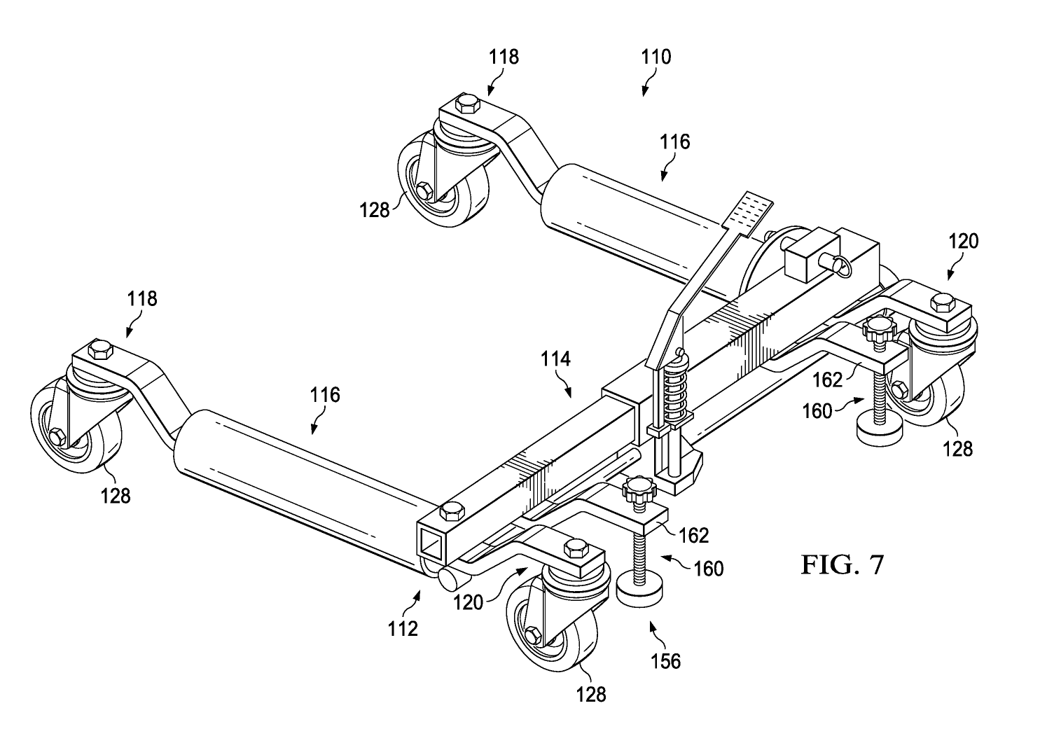

FIGS. 6 and 7 illustrate an alternative embodiment of a wheeled cart 110 that is similar to the wheeled cart 10 of FIG. 1. For example, the wheeled cart 110 can include a frame 112 having a cross member 114 and a pair of support arms 116. Each support arm 116 can include a distal end 118 and a proximal end 120 that each support one of a plurality of wheels 128. The wheeled cart 110 can also include a brake assembly 156. However, the brake assembly 156 can include a pair of foot members 160 that are each threadably coupled to the cross member 114 by a flange 162. The flanges 162 can be disposed between the proximal ends 120 of the support arms 116. Each of the foot members 160 can be selectively extendible between a retracted position (shown in FIG. 7) and an extended position by rotating the foot member 160 with respect to the flange 162. When the foot members 160 are in the retracted position, the foot members 160 can be spaced from a ground surface. When the foot members 160 are in the extended position, the foot members 160 can contact the ground surface and can extend beyond the wheels 128 such that two of the wheels 128 are lifted off of the ground surface to prevent rolling of the wheeled cart 110.

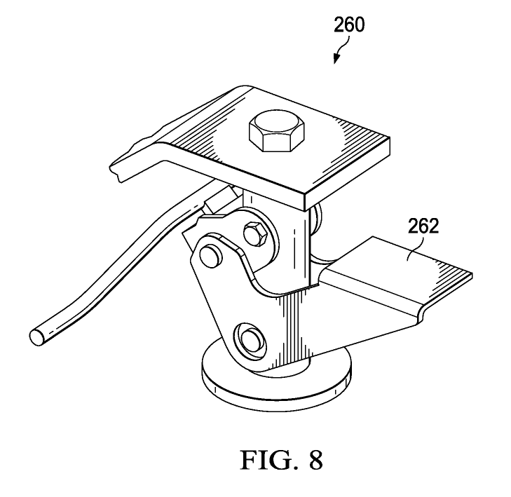

FIG. 8 illustrates an alternative embodiment of a foot member 260 that can be provided in place of one or both of the foot members 160 illustrated in FIGS. 6 and 7. A pedal assembly 262 can be associated with the foot member 260 and can be selectively depressed to facilitate extension of the foot member from a retracted position to the extended position to lift two wheels (e.g., 128) of a wheeled cart (e.g., 110) off of the ground surface.

The foregoing description of embodiments and examples has been presented for purposes of illustration and description. It is not intended to be exhaustive or limiting to the forms described. Numerous modifications are possible in light of the above teachings. Some of those modifications have been discussed and others will be understood by those skilled in the art. The embodiments were chosen and described for illustration of various embodiments. The scope is, of course, not limited to the examples or embodiments set forth herein, but can be employed in any number of applications and equivalent devices by those of ordinary skill in the art. Rather, it is hereby intended that the scope be defined by the claims appended hereto. Also, for any methods claimed and/or described, regardless of whether the method is described in conjunction with a flow diagram, it should be understood that unless otherwise specified or required by context, any explicit or implicit ordering of steps performed in the execution of a method does not imply that those steps must be performed in the order presented and may be performed in a different order or in parallel.

What is claimed is:

1. A wheeled cart for a reel, the wheeled cart comprising:
a first support arm comprising a distal end, a proximal end, and a central portion extending between the distal end and the proximal end;
a second support arm comprising a distal end, a proximal end, and a central portion extending between the distal end and the proximal end;
a cross member coupled to each of the first support arm and the second support arm such that the cross member extends laterally between the first support arm and the second support arm;
a first roller rotatably coupled to the central portion of the first support arm;
a second roller rotatably coupled to the central portion of the second support arm;
a locking assembly associated with the first roller and configured to facilitate selective locking of the first roller; and
a plurality of wheels, each wheel of the plurality of wheels being rotatably coupled with one of the distal end of the first support arm, the distal end of the second support arm, the proximal end of the first support arm, and the proximal end of the second support arm.

2. The wheeled cart of claim 1 wherein the first roller and the second roller are journalled with respect to the first support arm and the second support arm respectively.

3. The wheeled cart of claim 1 wherein the cross member comprises a telescoping member that is configured to facilitate selective adjustment of a distance between the first roller and the second roller.

4. The wheeled cart of claim 1 wherein:
the first roller comprises an annular flange that defines a plurality of apertures;
the locking assembly comprises a pin that is slidably coupled with the cross member and is slidable between a locked position and an unlocked position;
when the pin is in the locked position, the pin is inserted into one aperture of the plurality of apertures of the annular flange to facilitate locking of the first roller; and
when the pin is in the unlocked position, the pin is spaced from the annular flange to facilitate unlocking of the first roller.

5. The wheeled cart of claim 4 wherein the locking assembly comprises a housing coupled with the cross member and the pin is slidably coupled with the housing.

6. The wheeled cart of claim 1 wherein, for each of the first support arm and the second support arm, the central portion is vertically offset from the distal end and the proximal end.

7. The wheeled cart of claim 6 wherein the cross member is coupled with the central portions of each of the first support arm and the second support arm.

8. The wheeled cart of claim 1 wherein the cross member is more proximate the proximal ends of the first support arm and the second support arm than the distal ends of the first support arm and the second support arm such that the cross member, the first support arm, and the second support arm cooperate to form a substantially c-shaped cart.

9. A wheeled cart for a reel, the wheeled cart comprising:
a first support arm comprising a distal end, a proximal end, and a central portion extending between the distal end and the proximal end;
a second support arm comprising a distal end, a proximal end, and a central portion extending between the distal end and the proximal end;
a cross member coupled to each of the first support arm and the second support arm such that the cross member extends laterally between the first support arm and the second support arm;
a first roller rotatably coupled to the central portion of the first support arm;
a second roller rotatably coupled to the central portion of the second support arm;
a plurality of wheels, each wheel of the plurality of wheels being rotatably coupled with one of the distal end of the first support arm, the distal end of the second support arm, the proximal end of the first support arm, and the proximal end of the second support arm; and
a brake assembly configured to prevent rolling of the wheeled cart on the plurality of wheels.

10. The wheeled cart of claim 9 wherein the brake assembly comprises a locking pedal associated with one wheel of the plurality of wheels and configured to selectively lock the one wheel.

11. The wheeled cart of claim 9 wherein:
the brake assembly comprises a foot member that is selectively extendible between a retracted position and an extended position; and
extending the foot member from the retracted position to the extended position facilitates lifting of at least one wheel of the plurality of wheels off of a ground surface.

12. The wheeled cart of claim 11 wherein the foot member comprises a threaded foot member.

13. The wheeled cart of claim 11 wherein the brake assembly further comprises a pedal assembly associated with the foot member and operable to facilitate selective extension of the foot member from the retracted position to the extended position.

14. The wheeled cart of claim 9 wherein the first roller and the second roller are journalled with respect to the first support arm and the second support arm respectively.

15. The wheeled cart of claim 9 wherein the cross member comprises a telescoping member that is configured to facilitate selective adjustment of a distance between the first roller and the second roller.

16. The wheeled cart of claim 9 wherein, for each of the first support arm and the second support arm, the central portion is vertically offset from the distal end and the proximal end.

17. The wheeled cart of claim 16 wherein the cross member is coupled with the central portions of each of the first support arm and the second support arm.

18. The wheeled cart of claim 9 wherein the cross member is more proximate the proximal ends of the first support arm and the second support arm than the distal ends of the first support arm and the second support arm such that the cross member, the first support arm, and the second support arm cooperate to form a substantially c-shaped cart.

19. A wheeled cart for a reel, the wheeled cart comprising:
a first support arm comprising a distal end, a proximal end, and a central portion extending between the distal end and the proximal end;
a second support arm comprising a distal end, a proximal end, and a central portion extending between the distal end and the proximal end;
a cross member coupled to each of the first support arm and the second support arm such that the cross member extends laterally between the first support arm and the second support arm;
a first roller rotatably coupled to the central portion of the first support arm;
a second roller rotatably coupled to the central portion of the second support arm;
a plurality of wheels, each wheel of the plurality of wheels being rotatably coupled with one of the distal end of the first support arm, the distal end of the second support arm, the proximal end of the first support arm, and the proximal end of the second support arm;
a brake assembly configured to prevent rolling of the wheeled cart on the plurality of wheels; and
a locking assembly associated with the first roller and configured to facilitate selective locking of the first roller.

20. The wheeled cart of claim 19 wherein:
the first roller comprises an annular flange that defines a plurality of apertures;
the locking assembly comprises a pin that is slidably coupled with the cross member and is slidable between a locked position and an unlocked position;
when the pin is in the locked position, the pin is inserted into one aperture of the plurality of apertures of the annular flange to facilitate locking of the first roller; and
when the pin is in the unlocked position, the pin is spaced from the annular flange to facilitate unlocking of the first roller.
